(19) United States
(12) Patent Application Publication
(10) Pub. No.: US 2015/0379967 A1
(43) Pub. Date: Dec. 31, 2015

(54) ORGANIC LIGHT EMITTING DISPLAY DEVICE AND DRIVING METHOD THEREOF

(71) Applicant: SAMSUNG DISPLAY CO., LTD., Yongin-City (KR)

(72) Inventor: Jin-Woo Kim, Yongin-City (KR)

(21) Appl. No.: 14/675,655

(22) Filed: Mar. 31, 2015

(30) Foreign Application Priority Data
Jun. 30, 2014 (KR) 10-2014-0080806

(51) Int. Cl. G09G 5/18; G09G 3/32

(52) U.S. Cl. CPC G09G 5/18; G09G 3/32; G09G 2330/021

(57) ABSTRACT

There are provided an organic light emitting display device and a driving method thereof, capable of precisely compensating for the degradation of pixels. The device includes a display panel including a pixel; a test-data generator configured to output first test data for emitting light in a first region during a first period to the display panel and to output second test data for emitting light in a second region during a second period to the display panel, a current measurer configured to generate a first value corresponding to a current level of a power line during the first period and to generate a second value corresponding to a current level of the power line during the second period, and a parameter adjustor configured to adjust a parameter of a life model equation of the pixel until a difference between the first and second values is within a predetermined range.

### CROSS-REFERENCE TO RELATED APPLICATION

This application claims priority to and the benefit of Korean Patent Application No. 10-2014-0080806, filed on Jun. 30, 2014, in the Korean Intellectual Property Office, the contents of which are incorporated herein by reference in their entirety.

### BACKGROUND

1. Field

Embodiments of the present invention relate to an organic light emitting display device and a method of driving the organic light emitting display device.

2. Description of the Related Art

In recent years, various types of flat-panel display devices having reduced the weight and volume in comparison to a cathode ray tube have been developed. Examples of the flat-panel display devices are a liquid crystal display, a field emission display, a plasma display panel, an organic light emitting display device, etc.

Among the FPD devices, the organic light emitting display device displays images using organic light emitting diodes (OLEDs) that generate light through the recombination of electrons and holes. The organic light emitting display device has a high response speed and is driven with low power consumption.

### SUMMARY

Embodiments of the present invention include an organic light emitting display device and a method of driving the organic light emitting display device, which are capable of precisely compensating for the degradation of pixels.

According to an embodiment of the present invention, there is provided an organic light emitting display device, including a display panel comprising a pixel; a test-data generator configured to output first test data for emitting light in a first region during a first period to the display panel, and configured to output second test data for emitting light in a second region during a second period to the display panel, a current measurer configured to generate a first value corresponding to a current level of a power line during the first period, and configured to generate a second value corresponding to a current level of the power line during the second period, and a parameter adjustor configured to adjust a parameter of a life model equation of the pixel until a difference between the first and second values is within a predetermined range.

The current measurer may include a current-to-voltage converter configured to convert a current of the power line into a voltage, a voltage accumulator configured to accumulate the voltage, and an analog-to-digital converter configured to analog-to-digital convert the accumulated voltage and thereby generate the first value or the second value.

The current-to-voltage converter may include a resistor provided on the power line, and a differential amplifier configured to amplify a voltage across the resistor.

The current measurer may include a current integrator configured to integrate a current of the power line and thereby generate a voltage, and an analog-to-digital converter configured to analog-to-digital convert the voltage and thereby generate the first value or the second value.

The organic light emitting display device may further include a data accumulator configured to accumulate image data that is provided to the display panel and thereby generate accumulated data, and a test-region determinator configured to determine the first region wherein the first region is a region where an accumulated light emitting value is highest in the display panel, based on the accumulated data.

The first region and the second region may not overlap each other.

The first region and the second region may have a same shape and size.

The life model equation may be expressed as the following equation:

PL=1+S·λ^{1/T} Equation

where PL denotes present light emitting efficiency that is compared with light emitting efficiency before the pixel is degraded, S denotes a first parameter, T denotes a second parameter, and λ denotes an accumulated light emitting value.

According to another embodiment of the present invention, there is provided a method of driving an organic light emitting display device, the method including generating a first value corresponding to a first current level of a power line while a first region of a display panel emits light, generating a second value corresponding to a second current level of the power line while a second region of the display panel emits light, and adjusting a parameter of a life model equation of a pixel until a difference between the first value and the second value is within a predetermined range.

The first value may be obtained by converting the first current of the power line into a first voltage, integrating the first voltage, and analog-to-digital converting the integrated voltage while the first region emits light, and the second value may be obtained by converting the second current of the power line into a second voltage, integrating the second voltage, and analog-to-digital converting the integrated voltage while the second region emits light.

The first value may be obtained by integrating a first current to generate a first voltage and analog-to-digital converting the first voltage while the first region emits light, and the second value may be obtained by integrating a second current to generate a second voltage and analog-to-digital converting the second voltage while the second region emits light.

The first region is a region where an accumulated light emitting value is highest in the display panel.

The first region and the second region may not overlap each other.

The first region and the second region may have the same shape and size.

The life model equation may be expressed as the following equation:

PL=1+S·λ^{1/T} Equation

where PL denotes present light emitting efficiency that is compared with light emitting efficiency before the pixel is degraded, S denotes a first parameter, T denotes a second parameter, and λ denotes an accumulated light emitting value.

### BRIEF DESCRIPTION OF THE DRAWINGS

Example embodiments of the present invention will be described more fully hereinafter with reference to the accompanying drawings; however, the present invention may be embodied in different forms and should not be construed as limited to the embodiments set forth herein. Rather, these example embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram schematically illustrating an organic light emitting display device according to an embodiment of the present invention;

FIG. 2 is a conceptual view illustrating an operation of the organic light emitting display device shown in FIG. 1;

FIG. 3 is a block diagram illustrating an embodiment of a current measuring unit shown in FIG. 1;

FIG. 4 is a detailed circuit diagram illustrating a voltage accumulator shown in FIG. 3;

FIG. 5 is a signal waveform diagram illustrating the operation of the organic light emitting display device shown in FIG. 1;

FIG. 6 is a circuit diagram illustrating another embodiment of a current-to-voltage converter shown in FIG. 3;

FIG. 7 is a block diagram illustrating another embodiment of the current measuring unit shown in FIG. 1;

FIG. 8 is a block diagram schematically showing an organic light emitting display device according to another embodiment of the present invention; and

FIG. 9 is a flowchart illustrating a method of driving an organic light emitting display device according to an embodiment of the present invention.

### DETAILED DESCRIPTION

Hereinafter, embodiments of the present invention will be described in detail with reference to the accompanying drawings.

The use of “may” when describing embodiments of the present invention refers to “one or more embodiments of the present invention.” It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. In contrast, when an element or layer is referred to as being “directly on,” “directly connected to”, “directly coupled to”, or “immediately adjacent to” another element or layer, there are no intervening elements or layers present.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

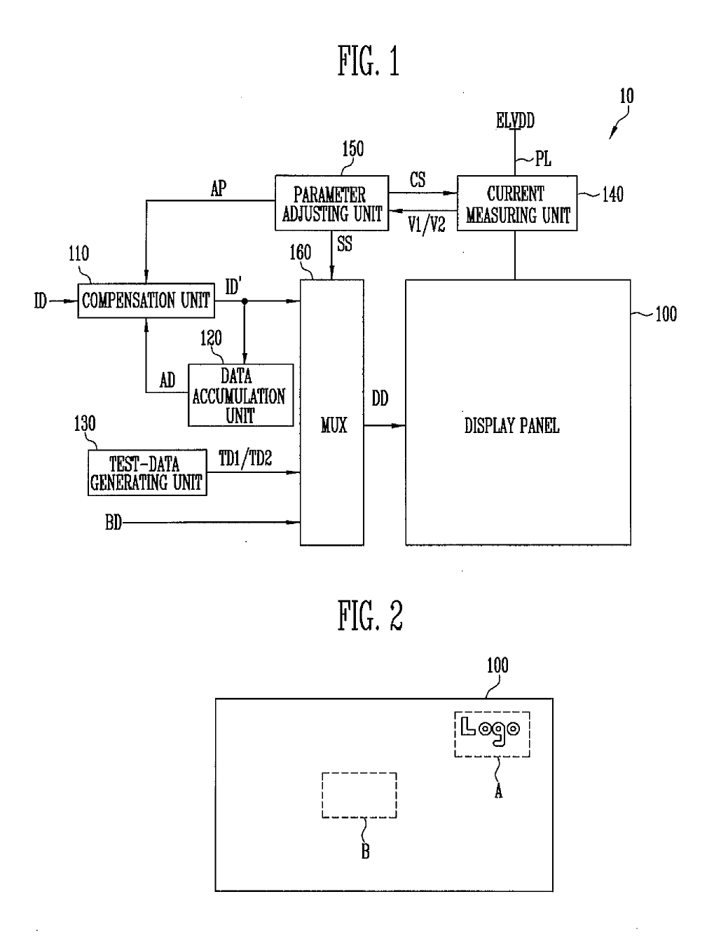

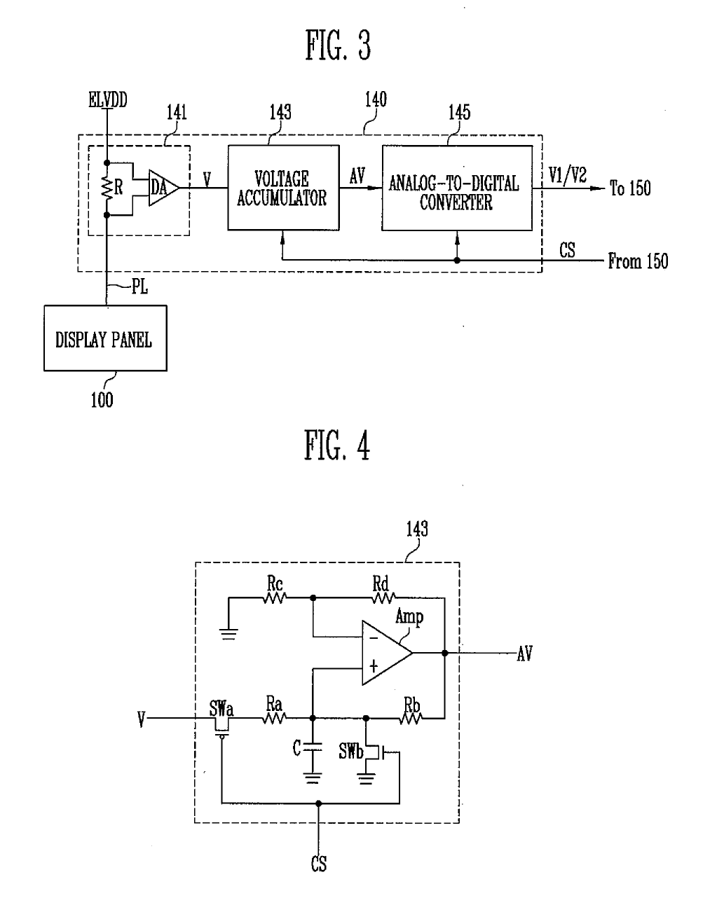

FIG. 1 is a block diagram schematically illustrating an organic light emitting display device according to an embodiment of the present invention, and FIG. 2 is a conceptual view illustrating the operation of the organic light emitting display device shown in FIG. 1.

Referring to FIGS. 1 and 2, the organic light emitting display device 10 includes a display panel 100, a compensation unit 110 (e.g., a compensator 110), a data accumulation unit 120 (e.g., data accumulator 120), a test-data generating unit 130 (e.g., a test-data generator 130), a current measuring unit 140 (e.g., a current measurer), a parameter adjusting unit 150 (e.g., a parameter adjustor 150) and a multiplexer 160.

The display panel 100 displays an image in response to display data DD that is output from the multiplexer 160. The display panel 100 includes pixels that are arranged at intersections between data lines and scan lines.

Each of the pixels emits light with luminance corresponding to (e.g., according to) a data signal that is provided through an associated one of the data lines when a scan signal is provided through an associated one of the scan lines.

The compensation unit 110 converts accumulated data AD that is output from the data accumulation unit 120 and image data ID that is provided from an outside based on the life model equation of the pixel, and outputs converted image data ID′ to the multiplexer 160.

In this context, the life model equation of the pixel refers to an equation that models the light emitting efficiency of the pixel depending on an accumulated light emitting value. The light emitting efficiency of the pixel is gradually degraded as it is used. The light emitting efficiency of the pixel may be modelled as shown in the following Equation 1. That is, the life model equation of the pixel is expressed as the following:

$$PL = 1 + {S ( {\sum }_{i}^{ } ( {{t}_{i} ( \frac{{d}_{i}}{{d}_{max}} )}^{γ \cdot ACC} ) )}^{\frac{1}{T}} \qquad Equation 1$$

where PL represents the present light emitting efficiency which is compared with the light emitting efficiency before the pixel is degraded, S represents a first parameter, T represents a second parameter, Acc represents a third parameter, γ represents a gamma constant, tᵢ represents the light emitting time of the pixel in an ith frame, dₘₐₓ represents a maximum pixel value, and d; represents a pixel value in the ith frame. Here, the first parameter S is a negative number.

When the organic light emitting display device 10 is operated in an analog driving manner in which a current of a level corresponding to (e.g., according to) the gray level of the pixel during a certain period in one frame is supplied to an OLED to express the gray level, the light emitting time t; is a constant and the pixel value d; is variable.

In contrast, when the organic light emitting display device 10 is operated in a digital driving manner in which a certain level of current is supplied to the OLED during a period corresponding to (e.g., according to) the gray level of the pixel in one frame to express the gray level, the light emitting time tᵢ is variable and the pixel value dᵢ is the constant.

The light emitting efficiency PL of the pixel is reduced in proportion to the accumulated value of the light emitting time ti until it reaches a present frame, namely, an ith frame and/or the accumulated value of the pixel value dᵢ.

Herein, the ‘pixel value’ refers to a value that corresponds (e.g., is according to) to the light emitting gray level of the pixel during one frame.

Since the gamma constant γ and the third parameter Acc are almost constant in Equation 1, the Equation 1 may be simply expressed as the following Equation 2.

PL=1+S·λ^{1/T} Equation 2:

where λ represents the accumulated value of the pixel values provided to the pixel until it reaches the present frame.

The data accumulation unit 120 generates accumulated data AD including the accumulated light emitting values for the respective pixels. The data accumulation unit 120 accumulates the converted image data ID′ that is output from the compensation unit 110, generates the accumulated data AD, and outputs the generated accumulated data AD to the compensation unit 110.

The data accumulation unit 120 may accumulate the converted image data ID′ per frame. However, the data accumulation unit 120 may accumulate the converted image data ID′ at a cycle (e.g., a predetermined cycle) so as to reduce the volume of the accumulated data AD. Further, the data accumulation unit 120 may use various compression methods so as to reduce the volume of the accumulated data AD.

Although FIG. 1 illustrates that the data accumulation unit 120 accumulates the converted image data ID′ output from the compensation unit 110 to generate the accumulated data AD, the technical spirit of the present invention is not limited thereto. For example, unlike FIG. 1, the data accumulation unit 120 may directly accumulate the image data ID provided from the outside and generate the accumulated data AD.

The test-data generating unit 130 outputs first test data TD1 for emitting light in a first region A during a first period T1 (see FIG. 5) to the multiplexer 160, and outputs second test data TD2 for emitting light in a second region B during the second period T2 (see FIG. 5) to the multiplexer 160.

The test-data generating unit 130 may variously set the condition of determining the positions of the first region A and the second region B. For example, the positions of the first region A and the second region B may always be fixed. On the contrary, the positions may be randomly selected by the test-data generating unit 130.

In order for the parameter adjusting unit 150 to precisely adjust the parameters S and T, the first region A and the second region B may have the same or substantially the same shape and size and that the first region A and the second region B do not overlap each other. Further, either of the first region A and the second region B may include an interest region where the high accumulated light emitting value is expected, for example, a region where a logo of a broadcaster is marked.

The current measuring unit 140 outputs a digital value corresponding to a current level of the power line PL to the parameter adjusting unit 150 in response to a control signal CS that is output from the parameter adjusting unit 150. The current measuring unit 140 outputs a first value V1 corresponding to the current level of the power line PL during the first period T1 to the parameter adjusting unit 150 and outputs a second value V2 corresponding to the current level of the power line PL during the second period T2 to the parameter adjusting unit 150.

Although FIG. 1 illustrates that the power line PL is a line connecting an anode power source ELVDD with the display panel 100, the technical spirit of the present invention is not limited thereto. For example, the power line PL may be a line connecting a cathode power source (not shown) with the display panel 100, unlike FIG. 1.

The structure and operation of the current measuring unit 140 will be described in detail with reference to FIGS. 3, 4, 6 and 7.

The parameter adjusting unit 150 outputs a control signal CS to the current measuring unit 140 and outputs a selective signal SS to the multiplexer 160, thus entirely controlling the operation of the organic light emitting display device 10.

The parameter adjusting unit 150 receives the first value V1 and the second value V2 from the current measuring unit 140 and determines whether a difference between the first and second values V1 and V2 is within a range (e.g., a predetermined range). When the difference between the first and second values V1 and V2 is within the range (e.g., the predetermined range), the parameter adjusting unit 150 does not adjust the parameters S and T. In contrast, when the difference between the first and second values V1 and V2 exceeds the range (e.g., the predetermined range), the parameter adjusting unit 150 adjusts the parameters S and T and thereby changes the life model equation of the pixel.

The parameter adjusting unit 150 adjusts the parameters S and T until the difference between the first and second values V1 and V2 is within the range (e.g., the predetermined range).

The multiplexer 160 receives the selective signal SS that is output from the parameter adjusting unit 150, and outputs to the display panel 100 any one of: compensated conversion data ID′ that is output from the compensation unit 110; the first test data TD1 or the second test data TD2 that are output from the test-data generating unit 130; and the black data BD, as the display data DD.

The multiplexer 160 outputs the compensated conversion data ID′ as the display data DD to the display panel 100 during a normal driving period (i.e., period of displaying the image data provided from the outside).

The multiplexer 160 outputs any one of the first test data TD1, the second test data TD2, and the black data BD, as the display data DD, to the display panel 100 during the panel test period (i.e., parameter adjusting period). To be more specific, the multiplexer 160 outputs the first test data TD1 to the display panel 100 during the first period T1 in the panel test period, outputs the second test data TD2 to the display panel 100 during the second period T2, and outputs the black data BD to the display panel 100 during a reset period Tr.

According to an embodiment of the present invention, in order to adjust the parameters S and T, the first region A and the second region B should alternately emit light. Thus, the panel test period is may be set as a period selected by a user or a period when the organic light emitting display device 10 is turned on or turned off.

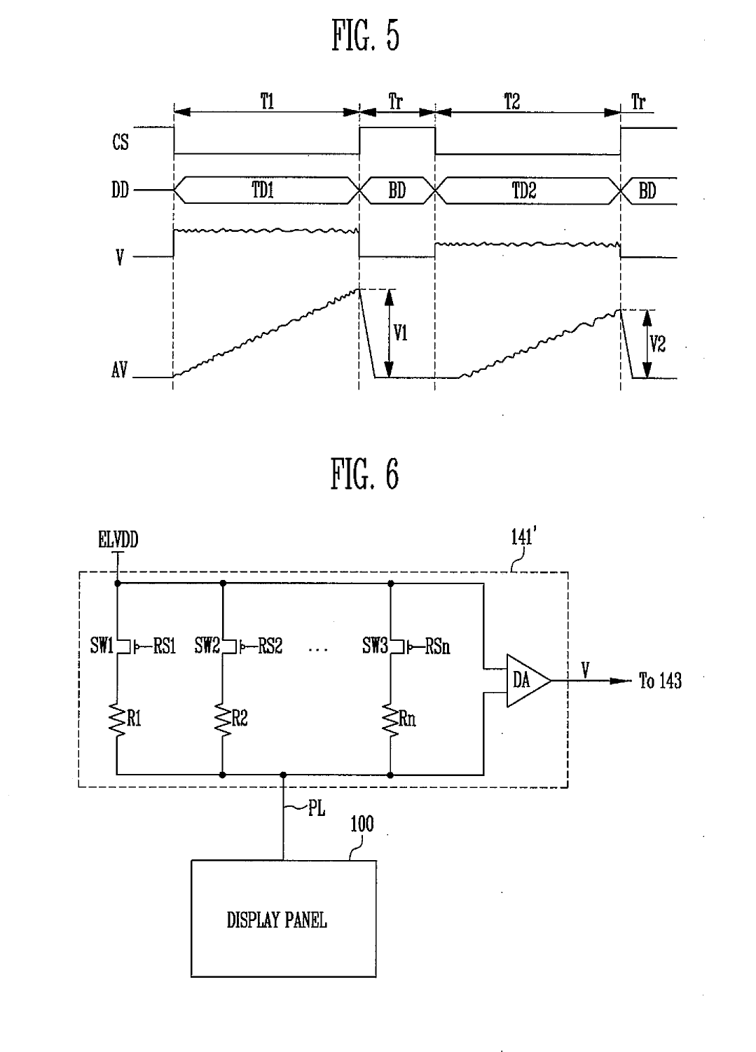

FIG. 3 is a block diagram illustrating an embodiment of the current measuring unit shown in FIG. 1, FIG. 4 is a detailed circuit diagram illustrating the voltage accumulator shown in FIG. 3, and FIG. 5 is a signal waveform diagram illustrating an operation of the organic light emitting display device shown in FIG. 1. For the convenience of description, FIG. 3 shows the anode power source ELVDD and the display panel 100 as well as the current measuring unit 140.

Referring to FIGS. 3 and 4, the current measuring unit 140 includes a current-to-voltage converter 141, a voltage accumulator 143 and an analog-to-digital converter 145.

The current-to-voltage converter 141 converts a current flowing through the power line PL to the voltage V. To this end, the current-to-voltage converter 141 may include a resistor R and a differential amplifier DA.

The resistor R is arranged on the power line PL, and the differential amplifier DA amplifies the voltage across the resistor R generated by the current flowing through the power line PL, and outputs the amplified voltage to the voltage accumulator 143.

The structure of the current-to-voltage converter 141 shown in FIG. 3 is one embodiment of the present invention, and the technical spirit of the present invention is not limited thereto. That is, the current-to-voltage converter 141 may be implemented in various structures.

The voltage accumulator 143 receives the control signal CS that is output from the parameter adjusting unit 150, accumulates the voltage V that is output from the current-to-voltage converter 141, and outputs the accumulated voltage AV to the analog-to-digital converter 145.

The voltage accumulator 143 accumulates the voltage V during the first period T1 or the second period T2 when the control signal CS is a first level, e.g., low level and outputs the accumulated voltage AV. Further, the voltage accumulator 143 discharges the accumulated voltage AV during the reset period Tr when the control signal CS is a second level, e.g., high level.

The voltage accumulator 143 may include switching elements SWa and SWb, resistors Ra, Rb, Rc and Rd, a capacitor C and an amplifier AMP.

The first electrode of the switching element SWa is connected to the current-to-voltage converter 141, the second electrode is connected to the resistor Ra, and a gate electrode is connected to the parameter adjusting unit 150.

The switching element SWa is connected between the current-to-voltage converter 141 and the resistor Ra and is turned on or off in response to the control signal Cs that is output from the parameter adjusting unit 150. For example, the switching element SWa is turned on in response to the first level of control signal CS, and is turned off in response to the second level of control signal CS.

Herein, the ‘first electrode’ refers to any one of a source electrode and a drain electrode, and the ‘second electrode’ refers to the remaining one of the source electrode and the drain electrode. That is, when the first electrode is the source electrode, the second electrode is the drain electrode. In contrast, when the first electrode is the drain electrode, the second electrode is the source electrode.

The first electrode of the switching element SWb is connected to a first input terminal (+) of the amplifier AMP, the second electrode is connected to the ground, and the gate electrode is connected to the parameter adjusting unit 150.

The switching element SWb is connected between the first input terminal (+) of the amplifier AMP and the ground, and is turned on or off in response to the control signal CS that is output from the parameter adjusting unit 150. For example, the switching element SWb is turned on in response to the second level of control signal CS, and is turned off in response to the first level of control signal CS.

The resistor Ra is connected between the switching element SWa and the first input terminal (+) of the amplifier AMP, the resistor Rb is connected between the first input terminal (+) of the amplifier AMP and the output terminal, the resistor Rc is connected between the second input terminal (−) of the amplifier AMP and the ground, and the resistor Rd is connected between the second input terminal (−) of the amplifier AMP and the output terminal.

The capacitor C is connected between the first input terminal (+) of the amplifier AMP and the ground.

When the first level of control signal CS is provided from the parameter adjusting unit 150, the switching element SWa is turned on and the switching element SWb is turned off. At this time, the capacitor C is charged with the voltage V that is output from the current-to-voltage converter 141. That is, while the control signal CS maintains the first level, the voltage V is continuously accumulated in the capacitor C.

In contrast, when the second level of control signal CS is provided from the parameter adjusting unit 150, the switching element SWa is turned off and the switching element SWb is turned on. At this time, the voltage AV accumulated in the capacitor C is discharged.

The analog-to-digital converter 145 converts the accumulated voltage AV into a digital value in response to the control signal CS that is output from the parameter adjusting unit 150. The analog-to-digital converter 145 converts the accumulated voltage AV into the digital value when the control signal CS is transferred from the first level to the second level (i.e., rising edge).

The analog-to-digital converter 145 converts the accumulated voltage AV at the end point of the first period T1 and outputs the converted value, as the first value V1, to the parameter adjusting unit 150. Further, the analog-to-digital converter 145 converts the accumulated voltage AV at the end point of the second period T2 and outputs the converted value, as the second value V2, to the parameter adjusting unit 150.

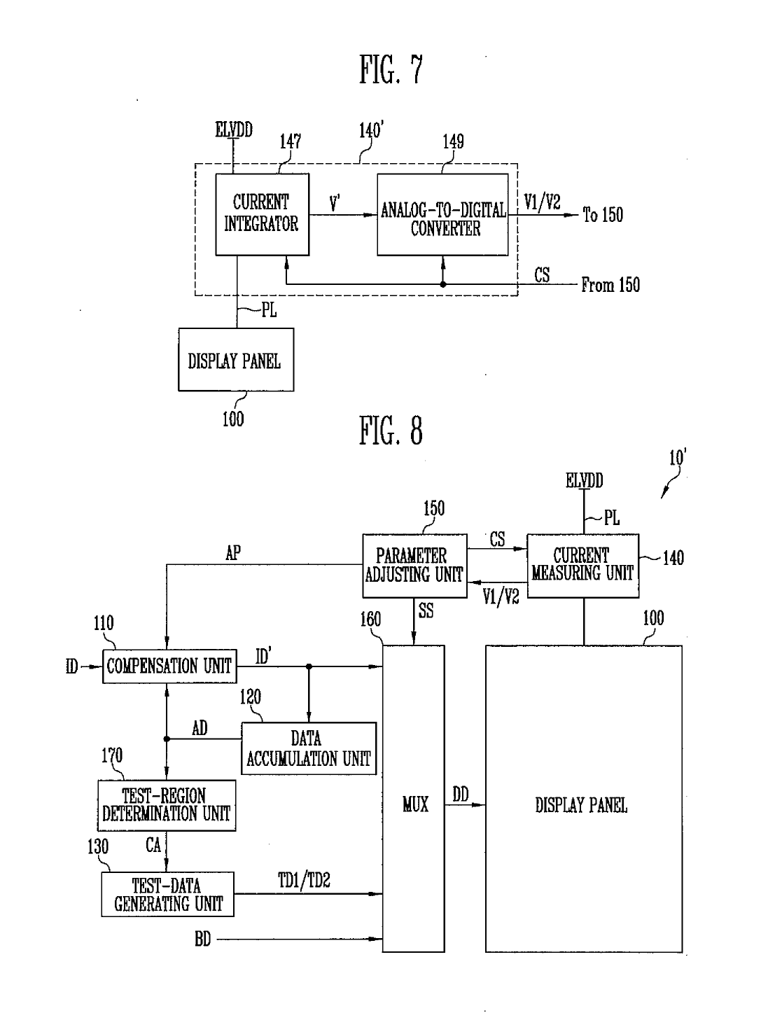

FIG. 6 is a circuit diagram illustrating another embodiment of the current-to-voltage converter shown in FIG. 3. For the convenience of description, FIG. 6 shows an anode power source ELVDD and a display panel 100 as well as a current-to-voltage converter 141′. The current-to-voltage converter 141′ shown in FIG. 6 is substantially equal or substantially similar to the current-to-voltage converter 141 shown in FIG. 3 except a plurality of resistors R1 to Rn and a plurality of switching elements SW1 to SWn. Thus, the description of elements common to FIGS. 3 and 6 will be omitted herein.

The current-to-voltage converter 141′ includes a plurality of resistors R1 to Rn and a plurality of switching elements SW1 to SWn.

Any one of the resistors R1 to Rn and a corresponding one of the switching elements SW1 to SWn are connected in series between the anode power source ELVDD and the display panel 100.

The resistors R1 to Rn have different resistance values.

Each of the switching elements SW1 to SWn is turned on in response to a corresponding one of the resistor control signals RS1 to RSn. The resistor control signals RS1 to RSn may be output from the parameter adjusting unit 150.

The parameter adjusting unit 150 may adjust the accuracy of current measurement depending on the first value V1 or the second value V2. For example, when the first value V1 or the second value V2 is small, the parameter adjusting unit 150 controls the resistor control signals RS1 to RSn to select the resistor having a high resistance value from the plurality of resistors R1 to Rn. In contrast, when the first value V1 or the second value V2 is large, the parameter adjusting unit 150 controls the resistor control signals RS1 to RSn to select the resistor having a low resistance value from the plurality of resistors R1 to Rn.

FIG. 7 is a block diagram illustrating another embodiment of the current measuring unit shown in FIG. 1. For the convenience of description, FIG. 7 illustrates an anode power source ELVDD and a display panel 100 as well as a current measuring unit 140′.

Referring to FIG. 7, the current measuring unit 140′ includes a current integrator 147 and an analog-to-digital converter 149.

The current integrator 147 integrates the current of the power line PL in response to the control signal CS output from the parameter adjusting unit 150, thus generating the voltage V′. The current integrator 147 integrates the current of the power line PL during the first period T1 and the second period T2 when the control signal CS is the first level, thus generating the voltage V′, and initializes the voltage V′ during the reset period Tr when the control signal CS is the second level.

The analog-to-digital converter 149 converts the voltage V′ that is output from the current integrator 147 into a digital value, in response to the control signal CS that is output from the parameter adjusting unit 150. The analog-to-digital converter 149 converts the voltage V′ at which the control signal CS is transferred from the first level to the second level into the digital value.

For example, the analog-to-digital converter 149 converts the voltage V′ at the end point of the first period T1 into the first value V1 and outputs the converted value to the parameter adjusting unit 150, and converts the voltage V′ at the end point of the second period T2 into the second value V2 and outputs the converted value to the parameter adjusting unit 150.

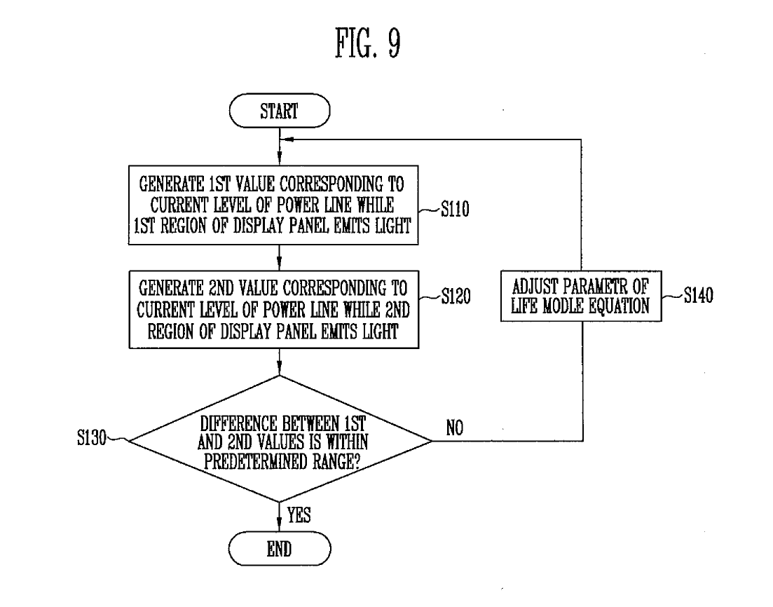

FIG. 8 is a block diagram schematically showing an organic light emitting display device according to another embodiment of the present invention. The organic light emitting display device 10′ of FIG. 8 is substantially equal or substantially similar to the organic light emitting display device 10 of FIG. 1 except that the organic light emitting display device 10′ further includes a test-region determination unit 170 (e.g., a test-region determinator 170). Thus, the description of elements common to FIGS. 1 and 8 will be omitted.

Referring to FIG. 8, the organic light emitting display device 10′ includes a display panel 100, a compensation unit 110 (e.g., a compensator 110), a data accumulation unit 120 (e.g., a data accumulator 120), a test-data generating unit 130 (e.g., a test-data generator 130), a current measuring unit 140 (e.g., a current measurer 140), a parameter adjusting unit 150 (e.g., a parameter adjuster 150), a multiplexer 160 and a test-region determination unit 170 (e.g., a test-region determinator).

The test-region determination unit 170 determines a first region A based on the accumulated data AD that is output from the data accumulation unit 120. The test-region determination unit 170 analyzes the accumulated data AD and determines the first region A to include a region where the accumulated light emitting value is highest in the display panel 100.

The test-region determination unit 170 outputs a coordinate value CA of the determined first region A to the test-data generating unit 130.

According to an embodiment, the test-region determination unit 170 may determine the second region B that has the same or substantially the same shape and size as the first region A. Here, the test-region determination unit 170 may determine a second region B to include a region in which the accumulated light emitting value is lowermost in the display panel 100.

As such, by adjusting the parameters S and T based on a current difference of the power line PL when regions, having a large difference in accumulated light emitting value, emit light, it is possible to apply a more accurate life model equation of the pixel at the time of being compensated for.

FIG. 9 is a flowchart illustrating a method of driving an organic light emitting display device according to an embodiment of the present invention.

Referring to FIG. 9, the organic light emitting display device 10 generates a first value V1 corresponding to the current level of the power line PL while the first region A of the display panel 100 emits light, at step S110. Further, the organic light emitting display device 10 generates a second value V2 corresponding to the current level of the power line PL while the second region B of the display panel 100 emits light, at step S120.

According to an embodiment, the positions of the first region A and the second region B may be fixed. According to another embodiment, the positions of the first region A and the second region B may be randomly selected. According to a further embodiment, the organic light emitting display device 10 may determine the position of the first region A and/or the second region B based on the accumulated data AD obtained by accumulating the image data ID provided to the display panel 100 or the converted image data ID′. The first region A and the second region B may have the same or substantially the same shape and size.

The organic light emitting display device 10 compares the first value V1 with the second value V2, at step S130. When a difference between the first value V1 and the second value V2 exceeds a range (e.g., a predetermined range), the organic light emitting display device 10 adjusts the parameters S and T of the life model equation of the pixel, at step S140. In contrast, when the difference between the first value V1 and the second value V2 is within the range (e.g., the predetermined range), the organic light emitting display device 10 does not adjust the parameters S and T of the life model equation of the pixel and finishes the parameter adjusting process (step S110 to S140).

The organic light emitting display device 10 repeats the parameter adjusting process (step S110 to S140) until the difference between the first value V1 and the second value V2 is within the range (e.g., the predetermined range), thus calculating the accurate life model equation.

By calculating the accurate life model equation through the parameter adjusting process (step S110 to S140), the degradation of the pixels may be precisely compensated for.

By way of summation and review, the OLED and transistor included in the pixel are gradually degraded as it is used. The degradation may cause a difference in luminance between the pixels. As a result, the difference in luminance may generate a luminance stain on the organic light emitting display device and lead to a reduction in image quality.

Various methods have been proposed to compensate for the difference in luminance between the pixels due to the degradation. For example, there is a known method of compensating for image data depending on an accumulated value obtained by accumulating pixel values that are provided to the respective pixels.

According to this method, the compensation value for each pixel is calculated by substituting the accumulated value of each pixel into the predefined life model equation of the pixel. However, unless the parameter of the life model equation of the pixel matches the parameter of the actual pixel, compensation effect may be significantly reduced.

The organic light emitting display device and the method of driving the organic light emitting display device according to the embodiment of the present invention allow the degradation of pixels to be precisely compensated for.

Exemplary embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. An organic light emitting display device, comprising:
a display panel comprising a pixel;
a test-data generator configured to output first test data for emitting light in a first region during a first period to the display panel, and configured to output second test data for emitting light in a second region during a second period to the display panel;
a current measurer configured to generate a first value corresponding to a current level of a power line during the first period, and configured to generate a second value corresponding to a current level of the power line during the second period; and
a parameter adjustor configured to adjust a parameter of a life model equation of the pixel until a difference between the first and second values is within a predetermined range.

2. The organic light emitting display device as claimed in claim 1, wherein the current measurer comprises:
a current-to-voltage converter configured to convert a current of the power line into a voltage;
a voltage accumulator configured to accumulate the voltage; and
an analog-to-digital converter configured to analog-to-digital convert the accumulated voltage and thereby generate the first value or the second value.

3. The organic light emitting display device as claimed in claim 2, wherein the current-to-voltage converter comprises:
a resistor provided on the power line; and
a differential amplifier configured to amplify a voltage across the resistor.

4. The organic light emitting display device as claimed in claim 1, wherein the current measurer comprises:
a current integrator configured to integrate a current of the power line and thereby generate a voltage; and
an analog-to-digital converter configured to analog-to-digital convert the voltage and thereby generate the first value or the second value.

5. The organic light emitting display device as claimed in claim 1, further comprising:
a data accumulator configured to accumulate image data that is provided to the display panel and thereby generate accumulated data; and
a test-region determinator configured to determine the first region,
wherein the first region is a region where an accumulated light emitting value is highest in the display panel, based on the accumulated data.

6. The organic light emitting display device as claimed in claim 1, wherein the first region and the second region do not overlap each other.

7. The organic light emitting display device as claimed in claim 1, wherein the first region and the second region have a same shape and size.

8. The organic light emitting display device as claimed in claim 1, wherein the life model equation is expressed as the following equation:
PL=1+S·λ^{1/T} Equation
where PL denotes present light emitting efficiency that is compared with light emitting efficiency before the pixel is degraded, S denotes a first parameter, T denotes a second parameter, and λ denotes an accumulated light emitting value.

9. A method of driving an organic light emitting display device, the method comprising:
generating a first value corresponding to a first current level of a power line while a first region of a display panel emits light;
generating a second value corresponding to a second current level of the power line while a second region of the display panel emits light; and
adjusting a parameter of a life model equation of a pixel until a difference between the first value and the second value is within a predetermined range.

10. The method as claimed in claim 9,
wherein the first value is obtained by converting the first current of the power line into a first voltage, integrating the first voltage, and analog-to-digital converting the integrated voltage while the first region emits light, and
wherein the second value is obtained by converting the second current of the power line into a second voltage, integrating the second voltage, and analog-to-digital converting the integrated voltage while the second region emits light.

11. The method as claimed in claim 9, wherein the first value is obtained by integrating a first current to generate a first voltage and analog-to-digital converting the first voltage while the first region emits light, and
the second value is obtained by integrating a second current to generate a second voltage and analog-to-digital converting the second voltage while the second region emits light.

12. The method as claimed in claim 9, wherein the first region is a region where an accumulated light emitting value is highest in the display panel.

13. The method as claimed in claim 9, wherein the first region and the second region do not overlap each other.

14. The method as claimed in claim 9, wherein the first region and the second region have a same shape and size.

15. The method as claimed in claim 9, wherein the life model equation is expressed as the following equation:
PL=1+S·λ^{1/T} Equation
where PL denotes present light emitting efficiency that is compared with light emitting efficiency before the pixel is degraded, S denotes a first parameter, T denotes a second parameter, and λ denotes an accumulated light emitting value.
